(19) United States
(12) Patent Application Publication
(10) Pub. No.: US 2016/0042407 A1
(43) Pub. Date: Feb. 11, 2016

(54) System and Method for Controlling Purchasing Online Advertisements in a Real-Time Bidding Environment Using a Modified Delivery Profile

(71) Applicant: MAXPOINT INTERACTIVE, INC., Morrisville, NC (US)

(72) Inventors: Michael Els, Cambridge, MA (US); Randy Reiss, Dripping Springs, TX (US)

(73) Assignee: MAXPOINT INTERACTIVE, INC., Morrisville, NC (US)

(21) Appl. No.: 14/455,592

(22) Filed: Aug. 8, 2014

(51) Int. Cl. G06Q 30/02

(52) U.S. Cl. CPC G06Q 30/0275

(57) ABSTRACT

A computer-implemented method for managing purchasing of online advertisements in a real-time bidding system is provided. A setpoint profile defining one or more changes in a setpoint value over time is accessed, wherein the setpoint value indicates a target number of advertisement purchases in a particular time period. A controller executes a control loop feedback algorithm intended to produce actual advertisement purchase results that track the setpoint profile over time. The actual advertisement purchase results may experience time lags when encountering changes in the setpoint value due to the operation of the control loop feedback algorithm. Thus, the method further includes executing a profile modification algorithm to modify the setpoint profile to account for such time lags associated with the actual advertisement purchase results.

### TECHNICAL FIELD

The present disclosure relates in general to the field of computer software and systems, and in particular, to a system and method for controlled purchasing of online advertisements in a real-time bidding environment.

### BACKGROUND

Online advertisement placements generally refer to the slots or space on the pages of a website that are available for displaying advertisements along with their content. Advertisers typically bid on these advertisement placements that are made available through real-time bidding (RTB) exchanges such as AdX, Admeld, Pubmatic, etc.

From a mechanical perspective, online advertisement placement requires a bidding server connected to RTB exchanges. The bidding server then receives bid requests via the RTB exchanges. A bid request occurs when a user/Internet surfer visits a website or publisher that is selling their advertisement space on an RTB exchange. Upon receiving a bid request, the bidding server has a very short period of time to respond to this request (generally under 50 ms). Since this bid response needs to occur in a very short period of time, it is difficult to run large scale models to predict what advertisements to buy and what price to pay for them.

At bid time, the bidding server has to act on some set of rules, models or system instructions that indicate which bid requests it should bid or pass on. This is a non-trivial problem since there are numerous (e.g., billions) requests that could be bought at any given time, those requests are very different and occur randomly throughout the day, and each request needs to be evaluated in milliseconds.

### SUMMARY

A method and system for controlling an amount of online advertisements being bought in a real-time bidding (RTB) environment is disclosed.

One embodiment provides a computer-implemented method for managing purchasing of online advertisements in a real-time bidding system, the method comprising: providing a controller programmed to execute a control loop feedback algorithm intended to produce actual advertisement purchase results that track a setpoint profile over time, the setpoint profile defining one or more changes in a setpoint value over time, wherein the setpoint value indicates a target number of advertisement purchases in a particular time period; and applying, by a computer, a profile modification algorithm to modify the setpoint profile to account for time lags associated with the actual advertisement purchase results, the time lags occurring in response to at least some of the setpoint value changes due to the operation of the control loop feedback algorithm.

Another embodiment provides a non-transitory computer readable medium containing computer-readable instructions stored therein for causing a computer processor to perform operations for managing purchasing of online advertisements in a real-time bidding system, the operations comprising: executing a control loop feedback algorithm intended to produce actual advertisement purchase results that track a setpoint profile over time, the setpoint profile defining one or more changes in a setpoint value over time, wherein the setpoint value indicates a target number of advertisement purchases in a particular time period; and applying a profile modification algorithm to modify the setpoint profile to account for time lags associated with the actual advertisement purchase results, the time lags occurring in response to at least some of the setpoint value changes due to the operation of the control loop feedback algorithm.

The above and other preferred features, including various novel details of implementation and combination of elements, will now be more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWINGS

The accompanying figures, which are included as part of the present specification, illustrate the various embodiments of the presently disclosed system and method and together with the general description given above and the detailed description of the embodiments given below serve to explain and teach the principles of the present system and method.

FIG. 1 illustrates an example system level architecture for an real-time bidding online advertising system, according to various embodiments;

FIG. 2 illustrates an example target delivery profile divided into a series of time segments, according to one embodiment;

FIG. 3 illustrates a flowchart for an example method dynamically controlling a purchasing by dynamically adjusting a pacing threshold value, according to one embodiment;

FIG. 4 illustrates an example time series of purchased impressions, and a corresponding Kalman-filtered curve, according to one embodiment;

FIG. 5 illustrates an example PID controller for dynamically adjusting a pacing threshold value, according to one embodiment;

FIG. 6 illustrates a plot of example results of an example pacing control process, according to one embodiment;

FIG. 7 illustrates another plot of example results of an example pacing control process, according to one embodiment;

FIG. 8 illustrates yet another plot of example results of an example pacing control process, according to one embodiment;

FIG. 9A illustrates an example of a time-lagged response provided by a PID control process;

FIG. 9B illustrates a technique for smoothing a target distribution curve used by a PID controller, to account for time-lagged response, according to one embodiment;

FIG. 9C illustrates another example modification of a target distribution curve used by a PID controller, to account for time-lagged response, according to one embodiment;

FIG. 10 illustrates a plot of example results of an example pacing control process incorporating a smoothed target distribution curve, according to one embodiment; and

FIG. 11 illustrates an example computer architecture that may be used for embodiments of the present system.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

A system and method for controlled purchasing of online advertisements in a real time bidding environment is herein disclosed. According to one embodiment, the computer-implemented method includes receiving a real-time bid request for an online advertisement campaign and determining a score of the real-time bid request. The score elicits desirability for the online advertisement campaign. The computer-implemented method further includes determining a pacing threshold for the online advertisement campaign and bidding on the real-time bid request based on the score of the real-time bid request and the pacing threshold. A bidding pace of the online advertisement campaign is monitored based on a number of impressions won for a given time period, and the pacing threshold is dynamically adjusted based on the bidding pace.

Each of the features and teachings disclosed herein can be utilized separately or in conjunction with other features and teachings to provide a system and method for combining past user events with real-time user events to rapidly respond to advertising opportunities. Representative examples utilizing many of these additional features and teachings, both separately and in combination are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of processes and symbolic representations of operations on data bits within a computer memory. These process descriptions and representations are the means used by those skilled in the data processing arts to most effectively convey the substance of their work to others skilled in the art. A process is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. The steps are not intended to be performed in a specific sequential manner unless specifically designated as such.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” or the like, refer to the action and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The methods or processes presented herein are not inherently related to any particular computer or other apparatus. Various general purpose systems, computer servers, or personal computers may be used with programs in accordance with the teachings herein, or it may prove convenient to construct a more specialized apparatus to perform the method steps. The structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure. It is also expressly noted that the dimensions and the shapes of the components shown in the figures are designed to help to understand how the present teachings are practiced, but not intended to limit the dimensions and the shapes shown in the examples.

Methods and systems for controlling the purchasing of online advertisements in a real-time bidding environment are disclosed. The methods and systems may use dynamic pacing to control the rate, or pace, at which advertisements are purchased (or bid on in an attempt to purchase) over a period of time, e.g., according to one or more defined target metrics of an advertising campaign. For example, some embodiments provide a dynamic pacing system designed to win a target number of bids (i.e., purchase a target number of advertisement impressions) to meet a target number of impressions for a particular advertisement campaign over a defined period of time. In some embodiments, the dynamic pacing system affects the number of bids won (impressions purchased) by adjusting a bidding pace over time, e.g., by dynamically adjusting one or more factors or thresholds for (a) identifying which bid requests to bid on and/or (b) determining a bid price for each such identified bid request. Because winning a bid request is not guaranteed upon placing a bid (as another entity may bid a higher price), this adds a stochastic element to the disclosed systems and methods.

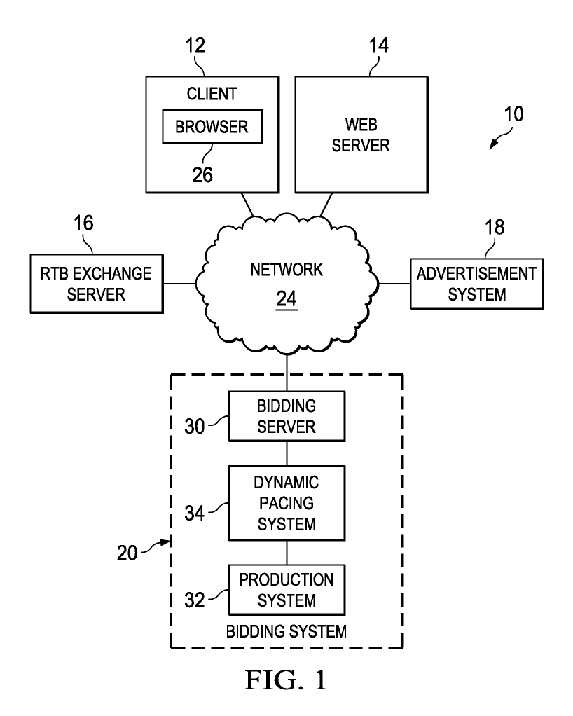

FIG. 1 illustrates an example system level architecture for a system 10 for controlled purchasing of online advertisements in a real-time bidding (RTB) environment, according to one embodiment. System 10 may include a plurality of clients 12, web servers 14, an RTB exchange system 16, one or more advertisement systems 18, and one or more bidding systems 20, all connected via a network 24. Each client 12 may host a browser 26 configured to view webpages hosted by web servers 14 via network 24. When a user at a client 12 clicks a link or otherwise opens a webpage, the web server 14 hosting the webpage sends data to RTB exchange system 16 indicating details of each ad placement on the requested page. RTB exchange system 16 then generates a real-time bid request for each ad placement on the requested page and sends each bid request to each bidding system 20 in the system 10. Thus, because each bid request relates to an ad placement for an instance of a page load, each bid request relates to an ad impression.

Each bidding system 20 is configured to analyze each incoming bid request and determine whether to bid on the respective placement/impression, and if so, a corresponding bid price.

RTB exchange system 16 may then determine a winning bid for each bid request, e.g., by comparing the respective prices of bid requests received from multiple different bidding systems 20, and inform the winning bidding system 20 or advertisement system 18 identified in the winning bid. The winning bidding system 20 or advertisement system 18 may then select and send an appropriate advertisement to the client 12, where the ad is served in the respective placement (which was identified in the bid request) of the webpage being loaded by the client's web browser 26.

Each bidding system 20 may include any suitable components and utilize any suitable models or algorithms to make bidding determinations for incoming bid requests from RTB exchange server 16. In some embodiments, bidding system 20 may be configured to generate a target delivery plan for purchasing/serving ad impressions for a particular ad campaign, and a pacing system for managing the rate of purchasing impressions over time.

In the example embodiment shown in FIG. 1, a bidding system 20 includes a bidding server 30, a production system 32, and a dynamic pacing system 34, each of which includes any suitable hardware, software, and/or firmware for performing the respective functions of the bidding system 20.

Bidding server 30 may be configured to score incoming bid requests and make bidding determinations based on rules and data supplied by production system 32 and dynamic pacing system 34, and generate and send bid responses to RTB exchange system 16 indicating a decision to bid or pass on each bid request (or alternatively may respond only to bid requests it wishes to bid on) and a corresponding bid price.

Production system 32 may be configured to generate and provide a list of rules to the bidding server 30, which uses the rules to score each incoming bid request. Production system 32 may also be configured to generate and provide a delivery plan to dynamic pacing system 34, which dynamically calculate a pacing threshold value based on the delivery plan. Dynamic pacing system 34 provides the dynamically calculated pacing threshold value to bidding server 30, which compares the bid request score for each incoming bid request against the current pacing threshold value to determine whether to bid on the bid request and, in some embodiments, a bid price.

Production system 32 may store or have access to parameters for an ad campaign (or multiple simultaneously-running ad campaigns), such as a campaign setup, target metrics (goals), and requirements, and may be configured to generate a delivery plan for purchasing and serving ad impressions for a defined lifetime of the campaign, or some other duration. The delivery plan may define different impression purchase quotas or targets for a given period of time, e.g., a month, a week, a day, an hour, a minute, or any combination of such time periods. In some embodiments, the delivery plan may specify a target delivery profile that defines a target rate of impressions purchased (target purchase rate) over time for a defined time period, which rate may be static or dynamic over the defined time period. For example, the target delivery profile may define a time-based curve of a dynamic target purchase rate over time, which curve may be generated based on known time-based dynamic information, such as a dynamic internet activity curve, a dynamic traffic curve for a particular website, a dynamic online traffic curve for users in a particular geographic region, or any other suitable data.

### Dynamic Pacing of Impression Purchasing

As mentioned above, production system 32 may provide the delivery plan to dynamic pacing system 34, which may dynamically calculate a pacing threshold value based on the delivery plan, including the target delivery profile. The dynamic pacing system 34 may segment the target delivery profile into a series of smaller time segments (e.g., 1 minute time segments), and calculate a target number of purchased impressions calculated for each time segment. As discussed below, in some embodiments dynamic pacing system 34 may dynamically adjust the target number of purchased impressions for individual time segments in real-time or substantially in real-time using control loop feedback, e.g., as implemented using a PID controller or PI controller. Partitioning the delivery plan into the smaller time segments may allow dynamic pacing system 34 to manage the impression purchasing process more accurately.

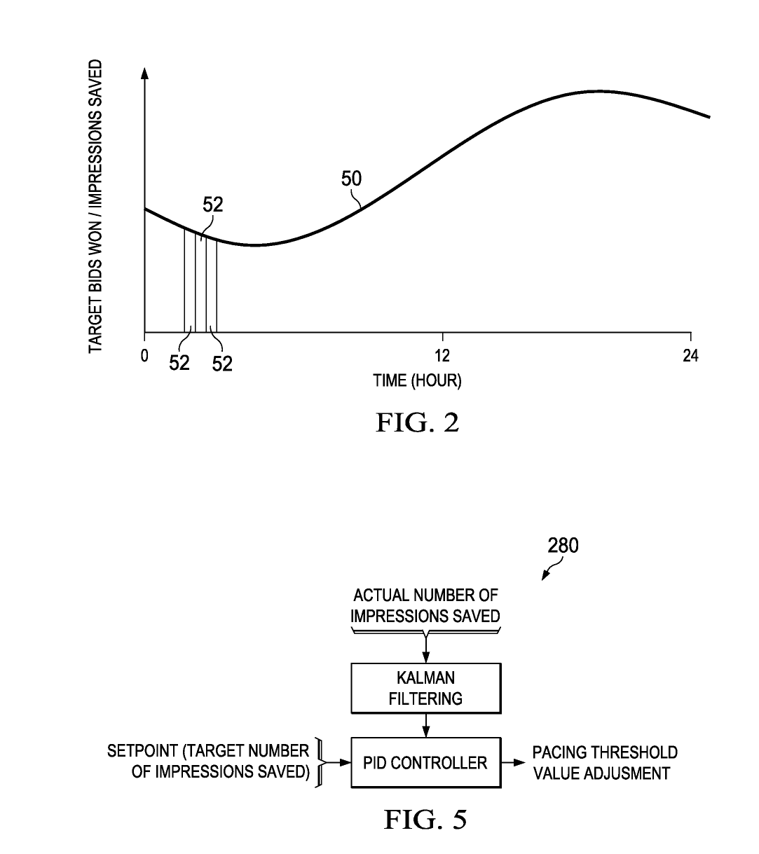

FIG. 2 illustrates an example of a target delivery profile 50 for a 24 hour period, which is divided by production system 32 into one minute segments 52 (not shown to scale). As discussed above, the target delivery profile 50 may be generated based on any suitable data, e.g., known time-dependent information, such as a dynamic internet activity curve, a dynamic traffic curve for a particular website, a dynamic online traffic curve for users in a particular geographic region, or any other suitable data. Further, as discussed above, production system 32 may calculate a target number of bids won/impressions served for each one minute segment based on a target number of bids won/impressions served for the 24 hour period and the relative size of that segment as defined by the target delivery profile 50.

Dynamic pacing system 34 may dynamically calculate a pacing threshold value designed to control the pace of impressions purchases over time such that the actual purchasing performance tracks the target delivery profile over time. For example, dynamic pacing system 34 may dynamically calculate the pacing threshold value based on the target number of purchased impressions for each time segment, and the ongoing performance of the campaign (e.g., number of impressions purchased in previous time segment(s)), and/or other relevant input data. In some embodiments, dynamic pacing system 34 may dynamically calculate the pacing threshold value in real-time or substantially in real-time (e.g., for each successive time segment) using control loop feedback, e.g., as implemented using a PID controller or PI controller.

Bidding server 30 may then determine whether to bid on each incoming bid request based on a comparison of the bid request score for that bid request and the current pacing threshold value as calculated by dynamic pacing system 34. For each bid request, bidding server 30 may determine to bid on the bid request if the respective bid request score is greater than or equal to the current pacing threshold value, calculate a corresponding bid price using any suitable model or algorithms, and communicate a bid response including the details of the bid to RTB exchange server 16, which may then determine a winning bid for the bid request, e.g., by comparing the respective prices of bid requests received from multiple different bidding systems 20, as discussed above.

Thus, in some embodiments, the bidding process for online advertisement impressions includes scoring bid requests for each ad placement/impression and deciding whether or not to bid on the impression based at least on the respective bid request score. For example, each bid request may be scored based on a relative level of desirability for purchasing the respective impression. Examples of such scores include a numerical score, a rank, a preference order, or a category to purchase or a general grouping concept. For example, each incoming bid request may be scored numerically on a scale from 0 to 20, from very undesirable (score=0) to very desirable (score=20). In another example embodiment, each incoming bid request is instead scored on a scale from 0 to 10. It is contemplated that any type of scoring schemes may be used to indicate a relative level of desirability without deviating from the present subject matter.

As discussed above, a dynamic pacing system may be employed to determine whether or not to bid on each bid request (and in some embodiments, a bid price for each bid) based on desirability scores calculated for the respective bid requests. In some embodiments, the present dynamic pacing system dynamically adjusts a pacing threshold value over time with the goals of (a) purchasing/serving a target number of online advertisements (impressions) in a particular time period, as defined by or based on the performance goals for a particular ad campaign, and (b) purchasing/serving the impressions according to a target delivery plan, e.g., by dynamically controlling the rate of impression purchases according to a target delivery profile or curves during the particular time period.

Further, in some embodiments, the dynamic pacing system 34 may dynamically update the delivery plan for an ad campaign over time during the execution of the campaign, e.g., based on the current performance or performance-to-date of the campaign. For example, dynamic pacing system 34 may dynamically update a target delivery profile (or the remainder of the target delivery profile) based on the number of impressions purchased/served during a particular time and the remaining number of impressions to achieve the campaign performance target.

As discussed above, dynamic pacing system 34 may determine a pacing threshold value (e.g., from 0-20) for each time segment, in real-time or substantially in real-time (e.g., by adjusting the pacing threshold value used during the previous time segment or maintaining the same pacing threshold value) based on a target number of impressions to win for a given time period, e.g., that time segment, multiple time segments, the remainder of the campaign duration, or other relevant time period. The pacing threshold value set by the present dynamic pacing system 34 represents the minimum bid request score that bidding server 30 will bid on. In one embodiment, at the beginning of the campaign or some other starting point within the campaign, dynamic pacing system 34 sets the pacing threshold for the first time segment (e.g., 1 min segment) to a predefined initial value, e.g., the maximum score (e.g., 20) which represents the most desirable bid requests, thereby beginning with maximum purchasing selectivity.

In some embodiments, dynamic pacing system 34 may then periodically determine whether to update or maintain the current pacing threshold value. For example, dynamic pacing system 34 may periodically—e.g., after each time segment or after each N time segments—determine whether to adjust or maintain the pacing threshold value based at least on (a) the number of bids won (i.e., impressions purchased) during that time segment (or that time segment plus N previous time segments or all previous time segments), and (b) the target number of bids to win (impressions to purchase) in the next time segment, next N time segments, or all subsequent time segments in a defined period or the full campaign. For example, if the number of bids won in a particular time segment (or previous N time segments) exceeds the target number for such time segment(s), dynamic pacing system 34 may increase the pacing threshold value with the intent to win fewer impressions in subsequent time segment(s) and thereby steer the performance back toward the target delivery profile or other target metric.

The pacing threshold value represents a measure of purchasing aggressiveness by the bidding system 20. For example, a threshold value close to the minimum score (e.g., 0), provides aggressive purchasing, in which the bidding system typically has little difficulty winning the target number of impressions for a given campaign. Adjusting the pacing threshold values toward the maximum score (e.g., 20) decreases the aggressiveness of the purchasing, by increasing the selectivity of bid requests to bid on.

Dynamic pacing system 34 may also (e.g., in combination with the dynamic adjustment of the pacing threshold value) control purchasing aggressiveness, and thus the pace of purchasing over time, by selecting or controlling bid prices for placed bids over time. For example, dynamic pacing system 34 may increase purchasing aggressiveness, and thus the number of impressions won, by offering higher bid prices; or alternatively decrease purchasing aggressiveness, and thus the number of impressions won, by offering lower bid prices. Thus, dynamic pacing system 34 may simultaneously incorporate both dynamic pacing threshold value control and dynamic bid price control to regulate the rate of impressions purchased over time as desired, e.g., based on target metrics.

In some embodiments, to adjust the pacing threshold value and change bidding parameters based on bidding pacing, the dynamic pacing system 34 accounts for the number of impressions being won (purchased) at the current pacing threshold value. An example equation for determining a sum of a conditional expectation (sumE) of a number of impressions that are won at a particular pacing threshold value at a point in time provides:

sumE [I|T],

where I is a number of impressions that are being won and T is the pacing threshold value at a point in time.

Typically, determining the number of impressions won is measured on a noisy time series, such that adjusting the threshold value with confidence may be difficult. In such system, there is typically some uncertainty regarding the number of impressions that the bidding system is purchasing at a given threshold. The bidding system may buy more or fewer impressions because of a change to the pacing threshold value or a change in activity in a RTB exchange system (e.g., more advertisements available for purchase). Or, there could be a large random fluctuation in the time series. In one embodiment, in order to more accurately estimate the number of bid requests that are being won, dynamic pacing system 34 applies a smoothing process to smooth a data set and separate the signal from the noise. For example, dynamic pacing system 34 may apply a calibrated Kalman filter to an observed time series. This model may provide a much more accurate representation of the number of impressions are being purchased at any given time segment or period.

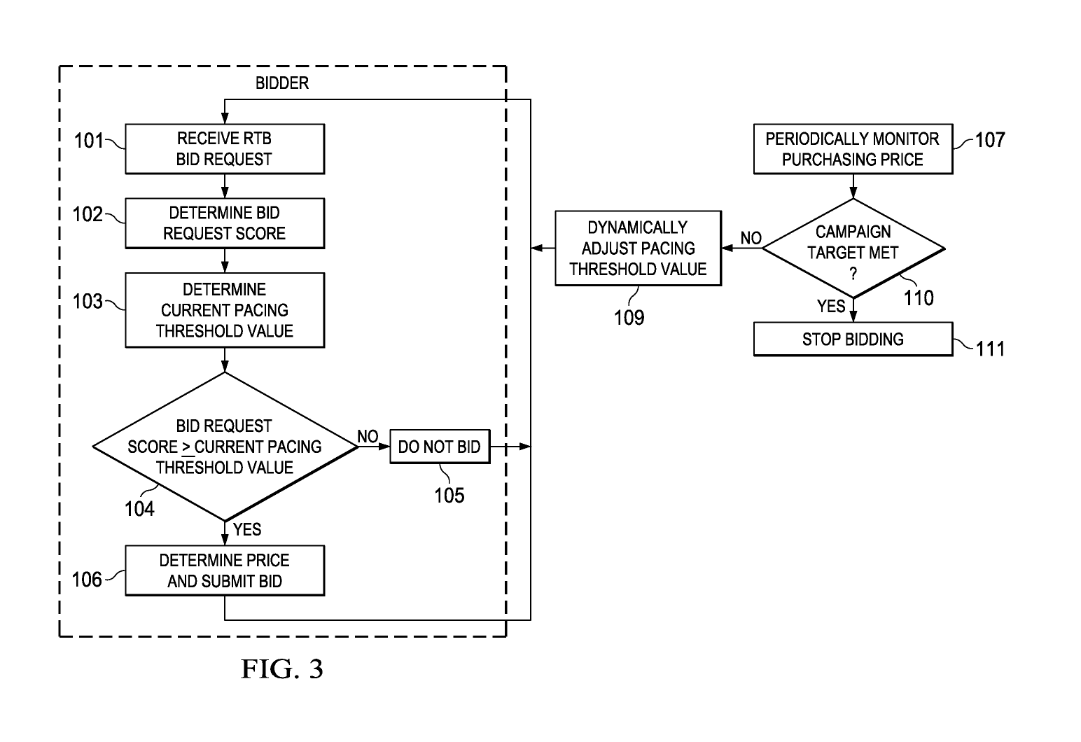

FIG. 3 illustrates a flowchart for a general method for dynamically controlling a pacing of purchasing for an online advertisement campaign in an RTB system, according to some embodiments. At step 101, bidding system 20 receives a real-time bid request from RTB exchange system 16 for an ad placement in a webpage being loaded via a client browser 26. Bidding server 30 scores the real-time bid request at step 102, e.g., based on rules supplied by production system 32. The bid request score indicates a desirability of the respective ad placement with respect to the online advertisement campaign, as discussed above.

Dynamic pacing system 34 determines a current pacing threshold value for the ad campaign at step 103, which value may be periodically determined and adjusted as discussed below. Bidding server 30 then compares the bid request score with the current pacing threshold value at step 104 to determine whether to bid on the placement identified by the bid request. If the bid request score fails to satisfy (e.g., is less than) the current pacing threshold value, bidding server 30 determines to not bid on the bid request at step 105, and the process returns to step 101 to process further incoming bid request. Alternatively, if the bid request score satisfies (e.g., is greater than or equal to) the current pacing threshold value, bidding server 30 generates and communicates a bid to the RTB exchange system 16 at step 106. Bidding server 30 may determine a price for the bid using any suitable data and algorithms.

As the ad campaign continues and bid requests are processed and either bid on or passed on, dynamic pacing system 34 periodically monitors the purchasing pace for the campaign over time based on the number of impressions won for a given time period at step 107. Dynamic pacing system 34 may monitor the pace at any desired frequency, e.g., every time segment (e.g., every 1 min), every N time segments, upon a predefined triggering event, or according to any other specified frequency or times. At step 108, dynamic pacing system 34 determines whether the goal of the online ad campaign (e.g., total number of impressions served) has been met. If the goal has not been met, dynamic pacing system 34 dynamically adjusts the pacing threshold value, if appropriate, based on various factors, e.g., the determined purchasing pace, a target distribution curve, one or more campaign goals or settings, etc., at step 109. The dynamically adjusted pacing threshold value is then used for evaluating subsequent incoming bid requests, as indicated by the arrow from step 109 to step 101, until the next adjustment of the pacing threshold value. Once the goal of the ad campaign is met, bidding system 20 stops bidding at step 110.

### Kalman Filtering

Dynamic pacing system 34 may employ one or more filters or other algorithms to increase the effectiveness of the dynamic control/adjustment of the pacing threshold value to increase the effectiveness of the dynamic control, e.g., by managing outlier data or rapid variations or spikes in the data. For example, in some embodiments, dynamic pacing system 34 may employ a Kalman smoothing filter or other smoothing filter to the number of impressions won during a previous time period, e.g., one or more time segments.

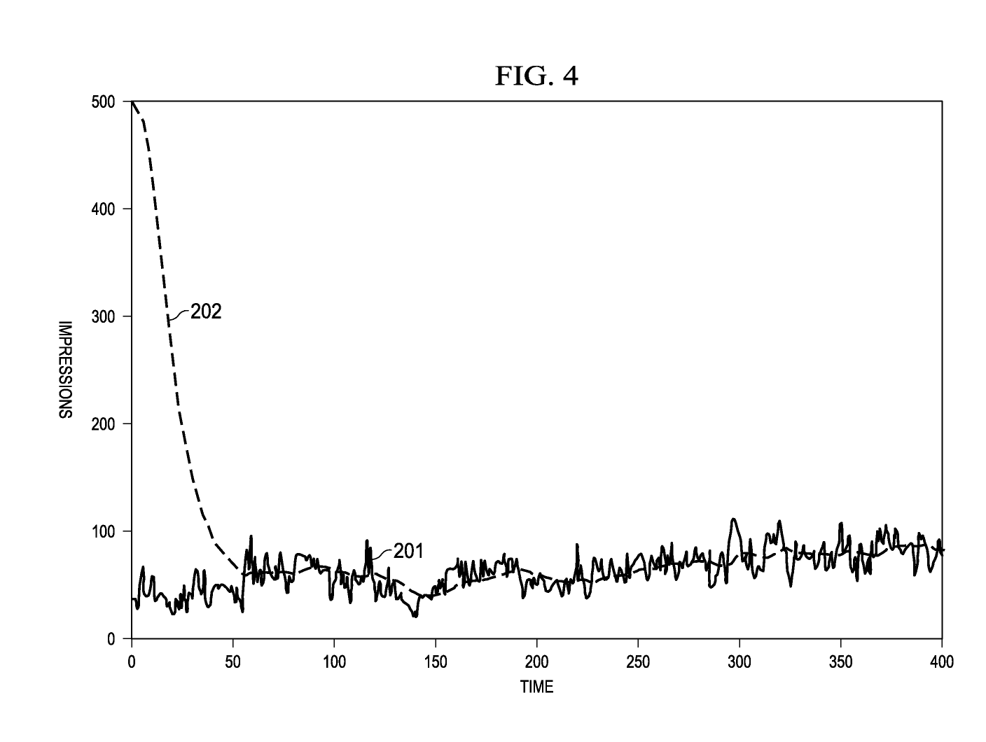

FIG. 4 illustrates an example of applying a Kalman filter to a time series of impressions won (purchased) by a bidding system 20 for a particular ad campaign. Line 201 shows the actual number of impressions won in each time segment, in this case each minute. Line 202 shows the Kalman-filtered data, which provides a prediction of the number of impressions expected to be won in a given time period (e.g., segment).

The Kalman-filtered data may be used as input for dynamically controlling the pacing threshold value. For example, the system may use the Kalman-filtered impressions won data to determine a current degree of divergence from a defined target number, e.g., as defined by a target distribution curve. Dynamic pacing system 34 may calculate a difference between the Kalman-filtered impressions won data for a particular time period (e.g., one or more time segments) and a target number of impressions purchased for that time period, and use such calculated difference for determining adjustments to the pacing threshold value over time.

As known in the art, a particular Kalman filter can be defined by a number of variables or parameters. These include the covariance of the process noise, Q, and the covariance of the observation noise, R. In some embodiments, the noise covariance parameters Q and R are held static throughout a pacing process (e.g., campaign). In other embodiments, observation noise covariance parameter R and process noise covariance parameter Q are both dynamically controlled/adjusted over time by dynamic pacing system 34. In still other embodiments, observation noise covariance parameter R is dynamically controlled/adjusted by dynamic pacing system 34, while the process noise covariance parameter Q is held constant (e.g., Q=1). For example, dynamic pacing system 34 may dynamically adjust covariance parameter R based on a moving window of variance, e.g., based on the calculated variance of the previous N measurements (wherein each measurement may be a number of impressions served in a particular time segment, for example). In one embodiment, dynamic pacing system 34 employs the following algorithm for dynamically controlling covariance parameter R:
1. MeasVar₁=the variance of the last N measurements (e.g., N=5).
2. R=HighLimit−(abs(1.0−(MeasVar₁−MeasVar_{T-1})*HighLimit
3. R cannot be less than LowLimit
4. Q=1; the variance of the model

Further, the measurement variance may be stabilized by taking the square root of the measurement and squaring the output.

it should be understood that the observation noise covariance parameters R and Q may be dynamically controlled using any other suitable algorithm.

### PID Control

In some embodiments, dynamic pacing system 34 employs a control process to calculate the direction and magnitude of adjustments to the pacing threshold value based at least in part on such Kalman-filtered (or otherwise filtered or smoothed) data. As an example of such control process, dynamic pacing system 34 may employ a proportional-integral-differential (PID) control process for dynamically controlling the pacing threshold value (or alternatively, a proportional-integral (PI) control process, without derivative-based control or a proportional derivative (PD) control process, without the integral-based control).

The PID control process takes in an error value and outputs a change variable (thereby implementing a “velocity controller”) or a raw output value (thereby providing a “positional controller”), depending on the particular embodiment. For example, in some embodiments, dynamic pacing system 34 employs a PID controller that takes in a calculated difference between a Kalman-estimated number of bids won/impressions served and a target number of bids won/impressions served, and outputs an adjustment to the pacing threshold value, or alternatively, outputs the actual value of the pacing threshold value. The PID control process is an online process, i.e., the PID control process computes input data serially, and thus need not run over historical data, and further relies on current information that is updated to reflect the current error.

FIG. 5 illustrates a PID controller 280 of dynamic pacing system 34, according to one embodiment. As shown, PID controller 280 receives as inputs (a) the target number of impressions served for each time segment (referred to herein as the “impression setpoint”), e.g., as defined by a segmented target distribution curve, and (b) the actual number of impressions served in such time segments, calculates a difference between the impression setpoint and actual impressions served, referred to as the “error,” and calculates and outputs an adjustment to the pacing threshold value. Alternatively, the PID controller may take inputs (a) as the target number of impression served for each time segment, and (b) the actual number of impression served in such time segments, calculate the error, and calculate the output as the actual pacing threshold. Thus, with reference to FIG. 2, the impression setpoint for each time segment 52 is the target number of bids won/impressions served for that time segment, as defined by the target distribution curve 50. Further, as shown in FIG. 5, the impressions served data may be filtered using a Kalman filter as discussed above, or otherwise filtered or smoothed using any suitable algorithm. PID controller 280 may account for the previous adjustment to the pacing threshold value and adjust the pacing threshold value based on various factors, e.g., the proportion of the last error, the sum (or integral) of previous errors, and the differential change in the error from the previous time period to the current time period.

The PID controller 280 may embody the following equation, incorporating the P (proportional), I (integral), and D (derivative) components:

K_{P}*(error)+K_{I}*∫(error)+K_{D}*d(error)/dt
wherein K_{P}, K_{I}, and K_{D} are tuning constants

Thus, the Proportional component, K_{P}*(error), is directly proportional to the error. The Integral component, K_{I}*∫(error), integrates the error over time, and thus acts as a continuous memory. The Derivative component, K_{D}*d(error)/dt, represents the change in error over time. The tuning constants K_{P}, K_{I}, and K_{D} can be tuned (e.g., adjusted by a user or automatically by dynamic pacing system 34) to provide a desired response, e.g., minimizing error by providing a fast response with little overshoot.

According to standard PID control techniques, PID controller 280 may calculate and use the “raw error” as the “error” term shown above, with the “raw error” defined as the mathematical difference between the actual number of impressions served for a particular time period (e.g., a time segment or N time segments) and the impression setpoint (i.e., target number of impressions served) for that time period.

However, in some embodiments, PID controller 280 may calculate and use a “relative error” as the “error” term shown above, with the “relative error” defined as the raw error for a particular time period divided by the impression setpoint for that time period:

Relative error=(raw error for time x)/(impression setpoint for time x)

The inventors have discovered that this approach simplifies the ability to tune PID controller 280, e.g., where PID controller 280 is used for multiple different ad campaigns. Thus, using the relative error instead of the raw error provides a cross-campaign standardized tuning technique.

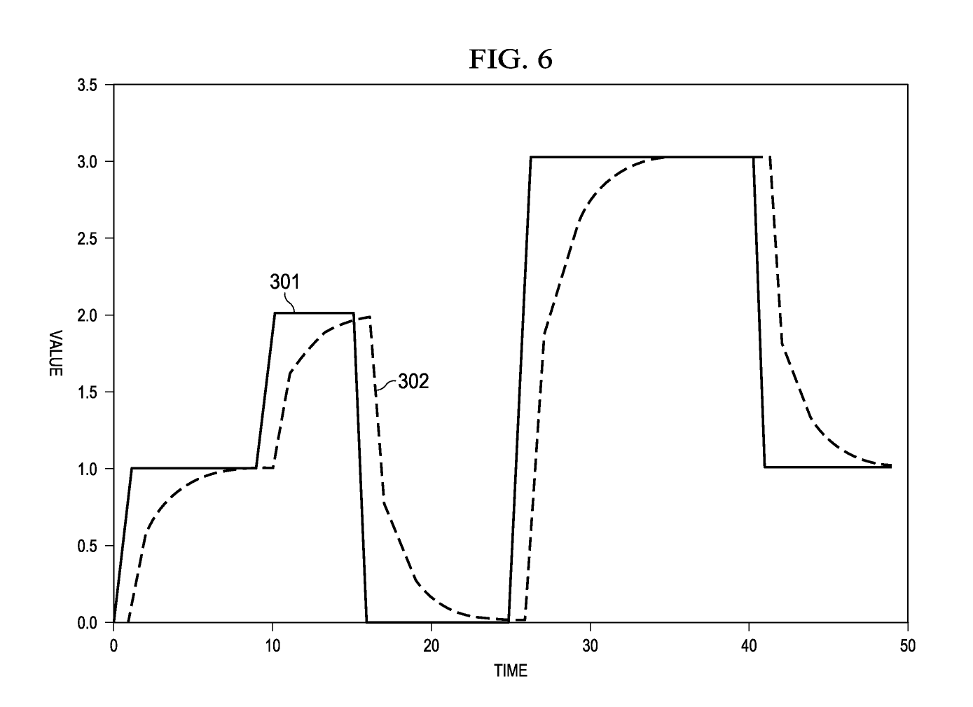

FIG. 6 illustrates an example operation of PID controller 280 to dynamically control the number of bids won/impressions served by dynamically adjusting a pacing threshold value, according to one embodiment. Line 301 indicates the impression setpoint (target number of impressions served) for each time segment over a 50 segment period. Thus, line 301 may represent a target distribution curve for an ad campaign. Line 302 indicates the actual number of impressions served for each time segment. PID controller 280 dynamically adjusts the pacing threshold value to influence the likelihood of winning incoming bid requests with the goal of tracking the moving impression setpoint (target distribution curve) over time.

PID controllers are typically configured to be sensitive to the particular system that they are used to control. In many commercial applications, PID controllers require tuning of relevant PID parameters (e.g., tuning constants) by experts to customize the controller to the particular application. In some embodiments of the present invention, the dynamic pacing system 34 automatically tunes and adjusts various PID parameters based on the current status of the system. Dynamic pacing system 34 may employ various optimization techniques for tuning the PID parameters of controller 280. For example, dynamic pacing system 34 may implement an automated heuristic tuning method, e.g., a Ziegler-Nichols method or any other variant, to tune one or more PID parameters of controller 280. In one embodiment, dynamic pacing system 34 employs a particle swarm optimization and evaluates the PID parameters after every step taken. Dynamic pacing system 34 may thus look back at the previous time period and simulate the step size that system 34 would have taken if the PID parameters were set to some other value(s). In this case, dynamic pacing system 34 may decide which alternative PID parameter values to evaluate. For example, dynamic pacing system 34 may adjust each of the PID parameter values in both possible directions (greater and smaller) at a time, and perform a simulation for each PID value or every combination of PID values. After the simulation is completed, dynamic pacing system 34 may compare the step size that all other theoretical PID models would have taken in the previous time period to the step size that is actually taken by PID controller 280. By evaluating the step size of all of the PID models, the dynamic pacing system 34 may selects the PID model that takes the best step size based on the set of PID parameter values that provided a results closest to a relevant impression setpoint or other target metric. This moves the model implemented by PID controller 280 slightly in a parameter space. At each iteration, the model implemented by PID controller 280 may be automatically and periodically adjusted over time based on how well it is suited to the current optimization task (e.g., how to adjust the threshold value) assigned to the controller. Another example is the use of a static tuning formula that takes the PID controller output and the value of the smoothed relative error and computes a specific set of tuning parameters that best meet the desired behavior of the PID loop for the particular ad campaign.

In some embodiments, dynamic pacing system 34 employs an optimization based on customized business rules. Examples of business rules include, for example, the biggest step size that dynamic pacing system 34 can select in set time intervals, maximum and minimum threshold values, and system stability checks.

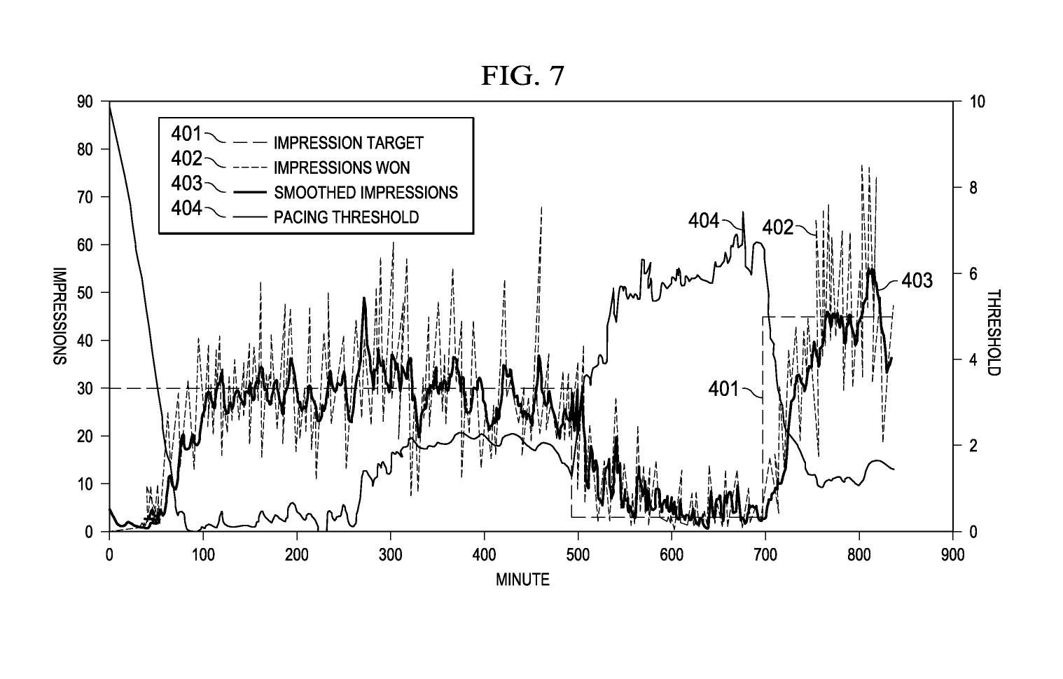

FIG. 7 illustrates an example plot for a dynamic pacing process performed by dynamic pacing system 34 employing a PID controller 280, for an example “campaign,” according to an example embodiment. Line 401 is a target distribution curve for a campaign duration of 835 minutes, which is divided into 835 one-minute time segments. Thus, the target distribution curve 401 indicates the impression setpoint for each one-minute time segment, which impression setpoint decreases at the 500 minute mark and then increases at the 700 minute mark, as shown. Target distribution curve 401 for the campaign may be predefined prior to beginning the pacing process. Target distribution curve 401 may be automatically generated by bidding system 20, manually input into bidding system 20 by a user, or some combination of the two. As discussed above, target distribution curve 401 may be designed such that total number of impression setpoints for all 835 one-minute time segments (i.e., the integrated area under curve 401) equals a predefined target number of impressions for the campaign. Further, target distribution curve 401 may be designed (shaped) based on various input data, e.g., a known internet activity curve, a known traffic pattern for a particular website, a known online traffic pattern for users in a particular geographic region, or any other suitable data. In some embodiment, target distribution curve 401 may remain static during the campaign. In other embodiments, target distribution curve 401 may adjusted during the campaign, by a user or automatically by bidding system 20, e.g., if the actual performance of the campaign substantially deviates from the target or if there is a detection that the internet usage patterns of target users has changed.

Line 402 indicates the number of impressions that are actually won in each one-minute time segment. As shown, line 402 varies sharply from minute to minute. As discussed above, the actual impression served data may be filtered or smoothed. Thus, line 403 is a Kalman-filtered version of the actual data of line 402, which indicates the number of impressions expected to be won in each time segment. Line 404 indicates the pacing threshold value, which is automatically and dynamically adjusted by the auto-tuning PID controller 280 implemented by dynamic pacing system 34, as discussed above. PID controller 280 adjusts the pacing threshold value with the goal of matching the actual number of impressions served indicated by lines 402/403 with the target distribution curve 403 as best as possible.

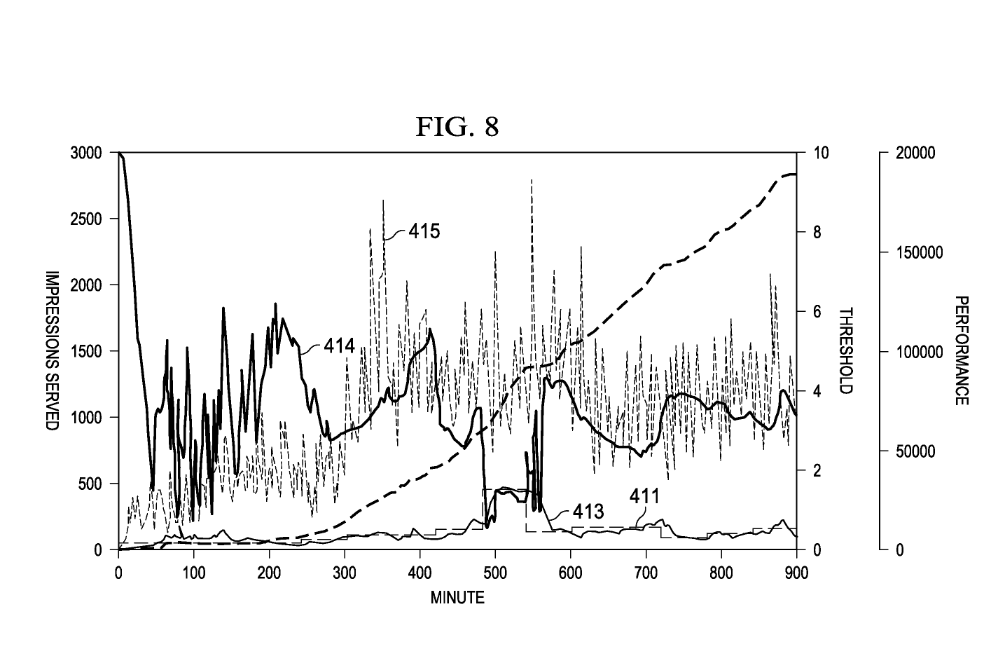

FIG. 8 illustrates another example plot for a dynamic pacing process performed by dynamic pacing system 34 employing a PID controller 280, for another example “campaign,” according to an example embodiment. Line 411 is a predefined target distribution curve for the campaign, in this case a 900 minute campaign, again divided into one-minute time segments. Line 415 indicates the number of bid requests received by the bidding system 20 during each time segment. Line 413 indicates a smoothed version of the actual impressions served data, e.g., corresponding to line 403 of FIG. 8. Line 414 indicates the dynamically adjusted pacing threshold value.

### Setpoint Smoothing

As can be seen in FIGS. 7 and 8, with dynamic control of a parameter using PID control (e.g., the pacing threshold value in this case) or other feedback-loop control, there is typically a time lag involved in the dynamic response (e.g., actual impressions served) to a change in the setpoint (e.g., impression setpoint). After the time lag, the response is then steered to match the setpoint. In a typical industrial control, these aspects of PID control are typically not problematic, as the typical goal is to achieve a setpoint value (e.g., temperature or pressure) in a reasonable duration of time without overshooting the setpoint. Thus, the key issue is the instantaneous difference between the actual parameter value and the setpoint value. In contrast, in the context of an online ad campaign, a key goal as discussed herein is to serve a target number of impressions over the campaign duration, which is represented by the integrated area under the target distribution curve (i.e., moving setpoint curve). Thus, unlike in an industrial application, in the present application the integrated area under the response curve is important, as it should match the integrated area under the target distribution curve (i.e., the target number of impressions for the campaign). In this regard, the time lag associated with the response may provide an integrated area under the response curve to that is greater than or less than the integrated area under the target distribution curve.

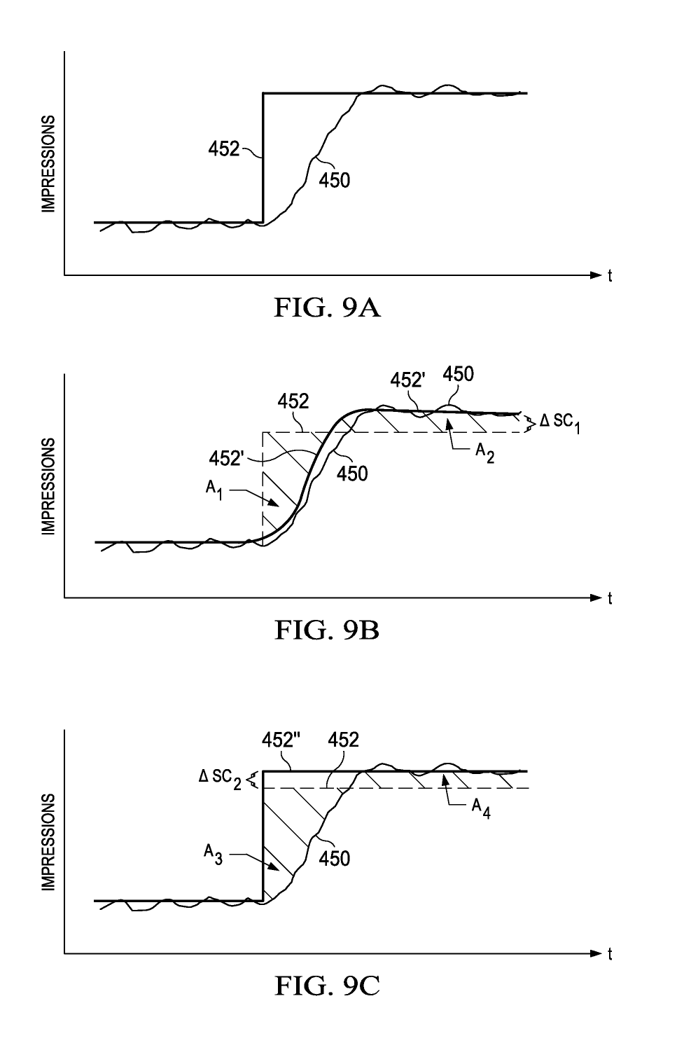

FIG. 9A illustrates an example of the phenomenon discussed above. As shown, the dynamic response in the actual impressions served, indicated at 450, involves a time lag to before reaching the impression setpoint, indicated at 452, after a change in the setpoint.

Thus, in some embodiments, the target distribution curve (moving setpoint curve) is automatically modified by bidding system 20 (e.g., production system 32) such that the dynamic response to changes in the impression setpoint (defined by the target distribution curve), including the response time lag, is mathematically accounted for. For example, the target distribution curve may be modified such that changes in the impression setpoint are smoothed, and the magnitude of the setpoint change is increased to account for the response time lag.

As used herein, “smoothing” a change in the setpoint includes any manner of reducing the rate of change or abruptness associated with the setpoint change, e.g., by transforming an abrupt change (e.g., an instantaneous or square-wave-type change) into a curved transition, a linear sloped transition (having a non-zero duration), a stepped or otherwise incremental transition, or any other form of transition that decreases the rate of change or abruptness associated with the setpoint change.

FIG. 9B illustrates an example of such a modification to the target distribution curve 452 shown in FIG. 9A. The modified target distribution curve, indicated at 452′, provides a smoothed transition for the setpoint change, and increases the magnitude of the of the setpoint change as compared with the original curve 452, indicated at ΔSC₁. The PID control may provide a dynamic response that substantially follows the smoothed transition, such that the time lag between the actual response and the target distribution curve 452′ is substantially reduced, as compared with the original target distribution curve 452. The modified target distribution curve 452′ may be generated such that additional integrated area provided by the increased magnitude of the setpoint change, indicated as area A₂ is equal to the integrated area corresponding to the response time lag, indicated as area A₁. Thus, the total area under the modified target distribution curve 452′ is equal to the total area under the original target distribution curve 452. Thus, assuming the dynamic response provided by the PID control can substantially follow the smoothed transition, the total number of actual impressions served may substantially match the total target number of impressions served (i.e., the area under the actual impression served curve may substantially match the area under the original target distribution curve 452).

Although FIG. 9B shows a smoothing of a setpoint increase, setpoint decreases may be smoothed in the same or similar manner.

FIG. 9C illustrates another example modification to the target distribution curve 452, as an alternative to the modification shown in FIG. 9B. In this example, the magnitude of the setpoint change is increased, but the setpoint transition is not smoothed, resulting in the modified target distribution curve, indicated at 452″. The extent to which the magnitude of the setpoint change is increased, ΔSC₂, may be calculated such that expected additional integrated area provided by the increased magnitude of the setpoint change, indicated as area A₄ is equal to the expected integrated area corresponding to the expected response time lag, indicated as area A₃. The expected integrated areas A₃ and A₄ may be determined, e.g., based on historical data regarding time-lag responses to various setpoint changes.

Again, although FIG. 9C shows a modification of a setpoint increase, setpoint decreases may be modified in the same or similar manner (e.g., by increasing the magnitude of the setpoint decrease).

Bidding system 20 may modify the setpoint curve by executing a profile modification algorithm, e.g., to account for time lags associated with the actual advertisement purchase results caused by the operation of the control loop feedback algorithm, as discussed above. The profile modification algorithm may be programmed to modify the setpoint curve in any suitable manner, e.g., according to any suitable set of rules. For example, the profile modification algorithm may be configured to adjust one or more parameters of each setpoint change (referred to herein as “profile change parameters”) defined in the setpoint profile based on any suitable data (referred to herein as “profile modification input data”).

Profile change parameters for each setpoint change may include, e.g., a start time of the profile change, an end time of the profile change (which may be the same or different the begin time), a duration of the change, a pre-change value (e.g., impressions or impressions/time) at the start time of the change, a post-change value (e.g., impressions or impressions/time) at the end time of the change, a direction of the setpoint change (increase or decrease), a magnitude of the setpoint change, a rate or slope of the setpoint change, a time from the previous setpoint change defined by the setpoint profile, a time until the subsequent setpoint change defined by the setpoint profile, and/or any other parameter related to the setpoint change.

The profile modification algorithm may be programmed to modify any one or more of such profile change parameters in any defined manner based on any suitable profile modification input data. For example, profile modification input data may include data regarding the dynamic response in actual impressions served (e.g., curves 450 shown in FIGS. 9A-9C) resulting from different types of setpoint changes, e.g., where different types of setpoint change vary in magnitude, direction, or any combination of profile change parameters listed above. The dynamic response data may also be collected and stored as a function of one or more environmental parameters (e.g., current traffic conditions, volume of received bid requests, time of day, day of the week, geographic region, or any other environmental parameter), and/or as a function of one or more bidding system operational parameters (e.g., specific or current settings of PID controller 280, bidding server 30, dynamic pacing system 34, and/or production system 32).

The dynamic response data may be historical data loaded into or accessible by bidding system 30. Alternatively, bidding system 30 may collect such dynamic response data for the response of the feedback-loop control system (e.g., PID controller) over time for a number of ad campaigns implemented by bidding system 30. Thus, the profile modification algorithm may utilize dynamic response data collected from prior ad campaigns or prior periods of a current ad campaign to modify the setpoint profile for a current portion of a current ad campaign.

For example, to modify a particular setpoint change for a current ad campaign, the profile modification algorithm may identify historical dynamic response data corresponding to similar setpoint changes (e.g., sharing one or more common profile change parameters with the particular setpoint change), and modify the particular setpoint change based on such identified historical dynamic response data. For instance, the profile modification algorithm may determine an average of lost impression volume caused be the dynamic response lag (e.g., corresponding to integrated areas A₁ or A₃ shown in FIGS. 9B and 9C), calculate an increased magnitude to account for this lost impression volume (e.g., corresponding to magnitude increase ΔSC₁ or ΔSC₂ shown in FIGS. 9B and 9C), e.g., based on the known time until the subsequent setpoint change defined by the setpoint profile, and modify the setpoint profile accordingly.

As another example, the profile modification algorithm may generate mathematical algorithms for adjusting each setpoint change based on one or more profile change parameters of the respective setpoint change and based on the historical dynamic response data, and then simply apply the mathematical algorithms to modify each setpoint profile to be implemented by the bidding system 30.

In other embodiments, the profile modification algorithm may be programmed to modify the setpoint changes in a setpoint profile based (at least in part) on dynamic response data collected during the duration defined by the setpoint profile (e.g., one day), or in some embodiments, even during the dynamic response of the setpoint change to be modified or being modified, thereby providing real time or substantially real time control. For example, when a particular setpoint change of a currently-active setpoint profile is reached, the profile modification algorithm may monitor the dynamic response resulting from the feedback-loop control system (e.g., PID controller) and adjust one or more parameters of that setpoint change, e.g., the magnitude of the change, substantially in real-time. For example, with reference to FIG. 9C, the profile modification algorithm may monitor the actual impression data 450 for a predetermined period of time or until some predefined threshold event (e.g., 50% of the originally defined change magnitude is reached), and based on such monitored data, calculate or estimate the lost impression volume caused be the dynamic response lag (e.g., corresponding to integrated area A₃), calculate an increased magnitude to account for this lost impression volume (e.g., corresponding to magnitude increase ΔSC₂), e.g., based on the known time until the subsequent setpoint change defined by the setpoint profile, and modify the setpoint profile accordingly.

It should be understood that the above are example embodiments only, and that the profile modification algorithm may modify each setpoint change of each setpoint profile in any other suitable manner.

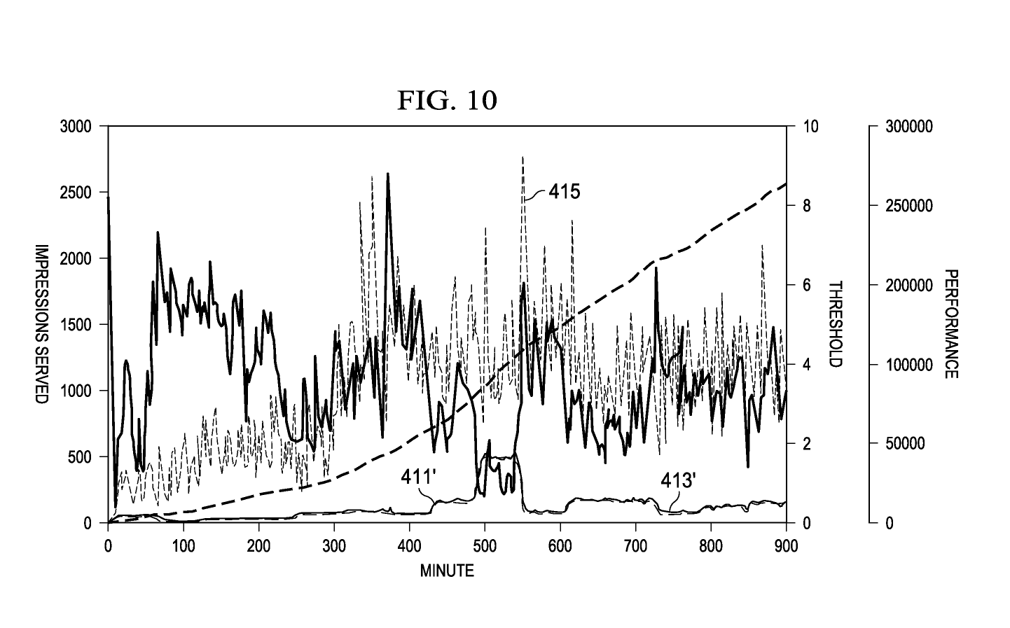

FIG. 10 illustrates an example implementation of the setpoint smoothing concepts discussed above with respect to FIG. 9B. In particular, FIG. 10 shows a plot similar to FIG. 8, but wherein a modified—in particular, smoothed—version of the target distribution profile 411 of FIG. 8, indicated in FIG. 10 as smoothed profile 411′, is generated and fed into PID controller 280 of bidding system 20. As shown, smoothed target distribution profile 411′ smooths both the setpoint increases and the setpoint decreases of the original target distribution profile 411 shown in FIG. 10. Further, it is clear from FIG. 10 that the response provided by the PID control (i.e., by dynamically adjusting the pacing threshold value based on the moving setpoint, etc.), in the form of the actual impressions served indicated at line 413′, tracks the smoothed target distribution profile 411′ significantly more closely than with the non-smoothed target distribution profile 411 shown in FIG. 8, which may increase the overall performance of the campaign, e.g., with respect to one or more defined goals or metrics of the campaign.

### Integral Windup

In some situations, the presence of numerical limits (minimum limit and maximum limit) on the pacing threshold value being dynamically adjusted by the PID controller causes a phenomenon referred to herein as “integral windup.” For example, When a spike in available impressions occurs, i.e., a spike in bid requests received at bidding system 20, the PID controller may attempt to avoid an excessive spike in impressions purchased by rapidly increasing the pacing threshold value. However, the pacing threshold value is limited by its maximum value, e.g., 20, and thus bidding system may still purchase excessive impressions (as compared to the relevant setpoint) during the available impression spike, and the integral term (I) of the PID control may accumulate a significant error, or “wind up,” due to the excess overshooting. Thus, when the number of available impressions drops, the PID controller takes some time to correct for the integral windup. In addition, as the integral term provides an offset that eliminates persistent bias or error over time, any error that the PID loop cannot correct for results in an accumulation of the integral term. One such source of error may be the intended limitation of adjustment of the pacing threshold as to limit movement for business purposes. The result of such limitation in the movement of the pacing threshold can also result in wind-up of the integral term.

In some embodiments, PID controller 280 may be configured to employ one or more reset techniques to reduce the effects of such integral windup. For example, PID controller 280 may employ an external reset, wherein the controller stops compounding the integral term when the pacing threshold value is adjusted to one of its limit values, e.g., 0 or 20. As another example, PID controller 280 may employ a back-calculation method that prevents intended limitations in the movement in the pacing threshold from causing integral windup. The back calculation of the integral term is the algebraic rearrangement of the PID algorithm as to assign the value to the integral term based on a known value of the threshold and the remaining terms of the controller. An example of such calculation is K_{I}*∫(error)=Output−K_{P}*(error)−K_{D}*d(error)/dt. It should be understood that any other suitable algorithms and techniques may be used to reduce or eliminate integral windup.

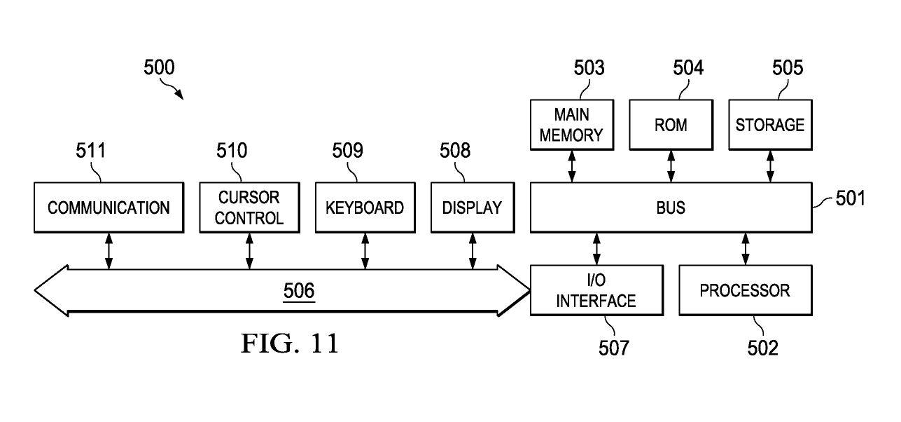

FIG. 11 illustrates an example computer architecture that may be used for the present system, according to one embodiment. The example computer architecture may be used for implementing one or more components described in the present disclosure including, but not limited to, the present system. One embodiment of architecture 500 includes a system bus 501 for communicating information, and a processor 502 coupled to bus 501 for processing information. Architecture 500 further includes a random access memory (RAM) or other dynamic storage device 503 (referred to herein as main memory), coupled to bus 501 for storing information and instructions to be executed by processor 502. Main memory 503 also may be used for storing temporary variables or other intermediate information during execution of instructions by processor 502. Architecture 500 may also include a read only memory (ROM) and/or other static storage device 504 coupled to bus 501 for storing static information and instructions used by processor 502.

A data storage device 505 such as a magnetic disk or optical disc and its corresponding drive may also be coupled to architecture 500 for storing information and instructions. Architecture 500 can also be coupled to a second I/O bus 506 via an I/O interface 507. A plurality of I/O devices may be coupled to I/O bus 506, including a display device 508, an input device (e.g., an alphanumeric input device 509 and/or a cursor control device 510).

The communication device 511 allows for access to other computers (e.g., servers or clients) via a network. The communication device 511 may include one or more modems, network interface cards, wireless network interfaces or other interface devices, such as those used for coupling to Ethernet, token ring, or other types of networks.

The above example embodiments have been described herein above to illustrate various embodiments of implementing a system and method for estimating an advertisement impression volume. Various modifications and departures from the disclosed example embodiments will occur to those having ordinary skill in the art. The subject matter that is intended to be within the scope of the present disclosure is set forth in the following claims.

1. A computer-implemented method for managing purchasing of online advertisements in a real-time bidding system, the method comprising:
executing, by a controller, a control loop feedback algorithm having a target of achieving actual advertisement purchase results that track a setpoint profile over time, the setpoint profile defining one or more changes in a setpoint value over time, wherein the setpoint value indicates a target number of advertisement purchases in a particular time period; and
executing, by a processor, a profile modification algorithm to modify the setpoint profile to account for time lags associated with the actual advertisement purchase results, the time lags occurring in response to at least some of the setpoint value changes due to the operation of the control loop feedback algorithm.

2. The computer-implemented method of claim 1, wherein the profile modification algorithm modifies the setpoint profile such that an integrated area under the modified setpoint profile is equal to an integrated area under the setpoint profile before modification.

3. The computer-implemented method of claim 1, wherein the profile modification algorithm is configured to smooth at least one of the setpoint value changes defined by the setpoint profile.

4. The computer-implemented method of claim 1, wherein the profile modification algorithm is configured to reducing a rate of change associated with at least one of the setpoint value changes defined by the setpoint profile.

5. The computer-implemented method of claim 1, wherein the profile modification algorithm is configured to increase a magnitude of at least one of the setpoint value changes defined by the setpoint profile.

6. The computer-implemented method of claim 1, wherein executing the profile modification algorithm to modify the setpoint profile to account for time lags associated with the actual advertisement purchase results comprises modifying the setpoint profile based on historical time lag data associated with the control loop feedback algorithm.

7. The computer-implemented method of claim 1, wherein the steps of executing the control loop feedback algorithm and executing the profile modification algorithm comprise:
(a) executing the control loop feedback algorithm to produce actual advertisement purchase results based on a defined setpoint profile;
(b) determining time lags associated with actual advertisement purchase results resulting from executing the control loop feedback algorithm based on the defined setpoint profile;
(c) executing the profile modification algorithm to modify the defined setpoint profile to account for the determined time lags; and
(d) after modifying the defined setpoint profile, executing the control loop feedback algorithm to produce actual advertisement purchase results based on the modified setpoint profile; and
(e) repeating steps (b) through (d) in an iterative manner over time.

8. The computer-implemented method of claim 1, further comprising:
receiving a series of bid requests from a real-time bidding exchange over a time duration, each bid request corresponding to an available advertisement placement; and
for each received bid request, determining whether to submit a purchase bid based at least on a current setpoint value at the time of receiving the bid request as defined by the modified setpoint profile.

9. The computer-implemented method of claim 8, wherein determining whether to submit a purchase bid for each received bid based at least on the current setpoint value comprises:
dynamically adjusting the value of a pacing threshold during the time period based at least on the modified setpoint profile; and
for each received bid request, determining whether to submit a purchase bid based at least on a current value of the dynamically adjusted pacing threshold.

10. The computer-implemented method of claim 9, comprising dynamically adjusting the value of the pacing threshold based at least on the modified setpoint profile by executing a control loop feedback algorithm including at least a proportional term and an integral term.

11. The computer-implemented method of claim 9, further comprising:
monitoring a number of advertisement placements purchased or served as a result of submitted purchase bids over time; and
dynamically adjusting the value of the pacing threshold during the time period based at least on (a) the modified setpoint profile and (b) the monitored number of advertisement placements purchased or served.

12. The computer-implemented method of claim 9, wherein determining whether to submit a purchase bid for each received bid request comprises:
for each received bid request:
determining a bid request score; and
determining whether to bid on that bid request based at least on the determined bid request score and the current value of the pacing threshold.

13. The computer-implemented method of claim 12, wherein the bid request score for each received bid request represents an attractiveness of the available advertisement placement associated with that bid request for a particular advertising campaign according to one or more predefined performance criteria of the particular advertising campaign.

14. A bidding system for managing purchasing of online advertisements in a real-time bidding environment, the bidding system comprising:
a processor; and
computer-readable instructions stored in non-transitory computer readable media and executable by the processor to:
execute a control loop feedback algorithm having a target of achieving actual advertisement purchase results that track a setpoint profile over time, the setpoint profile defining one or more changes in a setpoint value over time, wherein the setpoint value indicates a target number of advertisement purchases in a particular time period; and
execute a profile modification algorithm to modify the setpoint profile to account for time lags associated with the actual advertisement purchase results, the time lags occurring in response to at least some of the setpoint value changes due to the operation of the control loop feedback algorithm.

15. The bidding system of claim 14, wherein the profile modification algorithm modifies the setpoint profile such that an integrated area under the modified setpoint profile is equal to an integrated area under the setpoint profile before modification.

16. The bidding system of claim 14, wherein the profile modification algorithm is configured to smooth at least one of the setpoint value changes defined by the setpoint profile.

17. The bidding system of claim 14, wherein the profile modification algorithm is configured to reducing a rate of change associated with at least one of the setpoint value changes defined by the setpoint profile.

18. The bidding system of claim 14, wherein the profile modification algorithm is configured to increase a magnitude of at least one of the setpoint value changes defined by the setpoint profile.

19. The bidding system of claim 14, wherein executing the profile modification algorithm to modify the setpoint profile to account for time lags associated with the actual advertisement purchase results comprises modifying the setpoint profile based on historical time lag data associated with the control loop feedback algorithm.

20. The bidding system of claim 14, wherein the computer-readable instructions are executable to:
(a) execute the control loop feedback algorithm to produce actual advertisement purchase results based on a defined setpoint profile;
(b) determine time lags associated with actual advertisement purchase results resulting from executing the control loop feedback algorithm based on the defined setpoint profile;
(c) execute the profile modification algorithm to modify the defined setpoint profile to account for the determined time lags; and
(d) after modifying the defined setpoint profile, execute the control loop feedback algorithm to produce actual advertisement purchase results based on the modified setpoint profile; and
(e) repeat steps (b) through (d) in an iterative manner over time.

21. The bidding system of claim 14, wherein the computer-readable instructions are executable to:
receive a series of bid requests from a real-time bidding exchange over a time duration, each bid request corresponding to an available advertisement placement; and
for each received bid request, determine whether to submit a purchase bid based at least on a current setpoint value at the time of receiving the bid request as defined by the modified setpoint profile.

22. The bidding system of claim 21, wherein determining whether to submit a purchase bid for each received bid based at least on the current setpoint value comprises:
dynamically adjusting the value of a pacing threshold during the time period based at least on the modified setpoint profile; and
for each received bid request, determining whether to submit a purchase bid based at least on a current value of the dynamically adjusted pacing threshold.

23. The bidding system of claim 22, wherein the computer-readable instructions are executable to dynamically adjust the value of the pacing threshold based at least on the modified setpoint profile by executing a control loop feedback algorithm including at least a proportional term and an integral term.
